(19) United States
(12) Patent Application Publication
(10) Pub. No.: US 2004/0234137 A1
(43) Pub. Date: Nov. 25, 2004

(54) Image segmentation

(76) Inventors: Martin Weston, Petersfield Hampshire (GB); Michael James Knee, Hampshire (GB)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/472,208

(22) PCT Filed: Mar. 19, 2002
(86) PCT No.: PCT/GB02/01240

(30) Foreign Application Priority Data
Mar. 19, 2001 (GB) 0106770.1

(51) Int. Cl. G06K 9/62; G06K 9/34

(52) U.S. Cl. 382/225; 382/173

(57) ABSTRACT

In segmenting multidimensional image data, the data is represented as a set of points in a vector space which is the product of the vector space of pixel values and the vector space of pixel locations. Segments are determined by the result of clustering of the points, typically by simulating gravitational clustering of the points considered as point masses. From time to time the points are merged according to a proximity criterion, typically defined by mutual occupancy of a pre-defined hypercube in the vector space. The mapping of original pixels to points is tracked during the simulation process, so that pixels may be mapped to segments.

This invention relates to image segmentation.

There are many methods of image segmentation in existence. Classical methods of segmenting an image described by a one-dimensional parameter (e.g. luminance) fall into two categories, those based on edge detection (e.g. the Sobel operator) and those based on region detection (e.g. sieves, watershed transforms). Much less work has been done on segmentation of images described by two or more parameters (e.g. colour components, motion vectors). For this purpose, histogram processing is often used, but then the spatial (or temporal) localization of the regions is ignored.

It is an object of certain aspects of the present invention to provide improved methods of image segmentation utilising two or more parameters.

Accordingly, the present invention consists in one aspect in a method of processing multidimensional image data, characterised in that the data is represented as a set of point masses in a vector space which is the product of the vector space of pixel values and the vector space of pixel locations.

The invention will now be described by way of example, with reference to the accompanying drawings, in which:

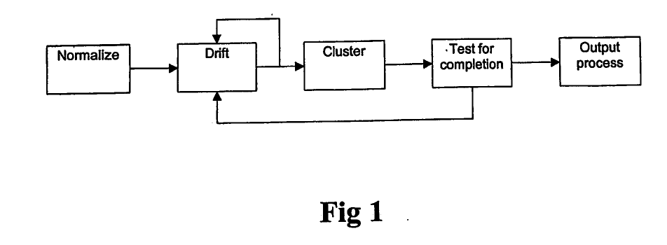

FIG. 1 is a block diagram illustrating the invention;

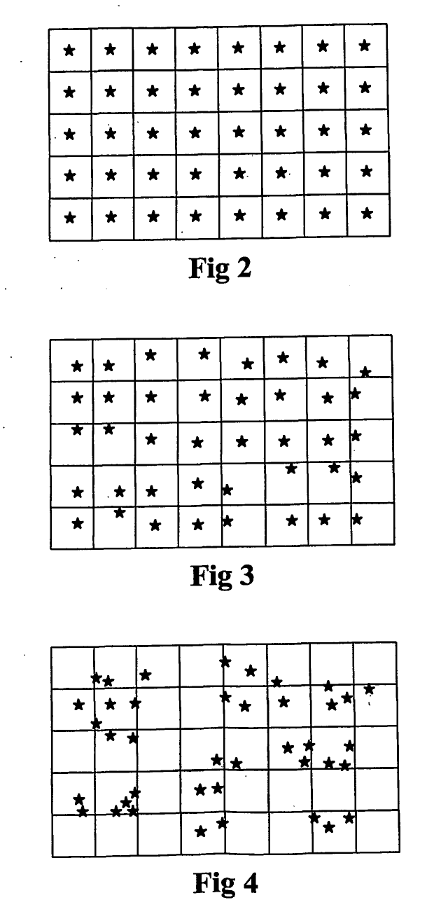

FIGS. 2 to 8 are schematic diagrams illustrating a method of image data processing according to an embodiment of the invention; and

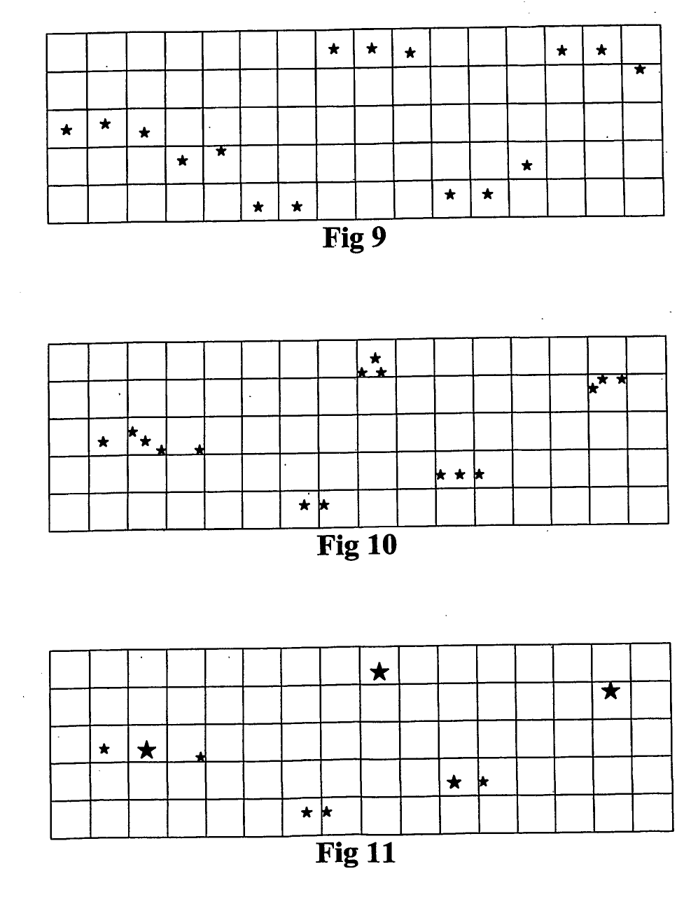

FIGS. 9 to 14 are schematic diagrams illustrating a method of image data processing according to another embodiment of the invention.

A method of image segmentation by gravitational clustering will now be described. First, the image (or image sequence) is represented as a set of point masses in multidimensional space, with one point for each pixel. The dimensionality N of the space is the sum of two numbers, S, which is the number of spatial and/or temporal dimensions on which the image is defined, and P, which is the dimensionality of the pixels themselves. Usually, S is equal to 2 if single images are being considered, or 3 if a sequence of images is being processed together and the temporal dimension is being considered. The value of P depends on what is being used to describe the image. In the simplest case of a luminance image, P=1. If the image is described by all three colour components, then P=3. In general, several numerical values may be attached to each pixel, for example:

Luminance values

Colour or colour-difference values

Motion vectors

Values of the above from multiple cameras

Higher-level results such as noise or texture estimates

These values may all be taken into account at once by suitable choice of the dimension P.

It is the object of the invention to provide a segmentation algorithm which takes into account all the available information present in the image.

Having represented the image in N-dimensional space, the algorithm works by simulating the action of gravitational clustering of the point masses. From time to time, the gravitational simulation is halted and the point masses are grouped into clusters according to some proximity criterion. Each cluster then represents a region in the segmented image, whose P-dimensional pixel value is given by the corresponding coordinates of the cluster.

There now follows a description of a practical implementation of the method. The main steps are shown in the block diagram which forms FIG. 1.

The steps will now be described in turn.

Normalize

This preprocessing step determines the relative scale of each of the N dimensions of the point mass coordinates. One method which has been found to work well is that each dimension is normalized to have a constant standard deviation. In the case of the first S coordinates, the original standard deviation can simply be calculated from the picture dimensions, while the standard deviations of the remaining P coordinates could be calculated by a single pass through all the pixels. A refinement to this method would be to force the normalization factors to be constant across sets of similarly scaled dimensions. For example, if two of the pixel dimensions are the horizontal and vertical components of motion vectors, the normalization factor for these two dimensions could be forced to be equal.

Drift

This operation simulates the effect of points drifting together under the influence of gravity. The simulation is carried out iteratively, using a short time interval. Each iteration works as follows:

For each point mass X, the gravitational influence on X of each of the surrounding points is calculated and accumulated, and then X is moved according to the calculated sum.

This step may be repeated several times before going on to the Cluster step.

There are two possibilities for organizing the data in the Drift step:

(i). the new position of each point is stored in a separate memory, so that only the old positions of the points are used when calculating the influence of each point, or

(ii). the new position of each point overwrites the old position as soon as it is calculated.

While (i) may seem to be an ideal approach, in practice we have found that (ii) works well and saves memory.

One problem with the drift phase is that the computational cost of calculating the influence of every point on every other point is currently prohibitive. It is therefore necessary to restrict the calculation to points that are known, or at least likely, to have a significant influence on the current point X. At the beginning of the process, the positions of the points in the S spatial dimensions follow a known pattern, so it is easy to ensure that all points that are within a certain distance in both those two dimensions are considered. Thus, for example, in a raster-scanned picture, a window covering a certain number of television lines could be used to ensure that every pixel within a certain distance of X will be considered. However, as the clustering process proceeds, none of the coordinates follows a known pattern and there is no guarantee that points within a certain distance will also be within a certain window in scanning order. Nevertheless, the fact that the number of points diminishes as the clustering process proceeds, together with a data structure that does not re-order clusters, have been found in practice to give satisfactory results while limiting the amount of processing to a reasonable level.

The simulation used in the invention calculates the total force on the point and then calculates the motion of the point with the following two assumptions:

(1) the point starts at rest, and

(2) the time interval is such that the change in the force due to the change in displacement can be ignored.

These assumptions simplify the calculations but lead to one of two problems, according to the “gravitational constant”, or equivalently the unit of time, that is applied in the simulation. Either

(a) the motion is too slow, or

(b) points that are close to each other move by more than the distance between them, producing instability in the simulation.

A solution that has been found to work in practice is to use a relatively long time constant, risking problem (b), but then additionally to limit the distance moved to half the distance between X and its nearest neighbour.

Cluster

This step attempts to identify clusters of points, and to replace each cluster by a single point whose mass is the sum of the individual point masses. To do this, the N-dimensional space is divided into equal hypercubes (bins) whose dimensions correspond to the level of proximity at which clustering is desired to take place.

In principle, each hypercube is searched for points that fall within it, and the exact coordinates of all such points are averaged (weighted by mass), while their masses are summed. At the end of the process there will then be at most one point within each bin.

In practice, the space of bins is very sparsely populated, and a much more efficient approach is to take each point in turn and test points that are likely to be near by (using the same approach as in the Drift phase) to see if they fall in the same bin.

Test for Completion

There are several possible tests for completion of the processing. The test may be combined with the output processing, indicating completion when some property of the output picture has been reached. Alternatively, the test may simply count the number of clusters, indicating completion when the count reaches or falls below a predetermined number.

Output Processing

There are two possible goals to the segmentation process. One is to produce a list of the pixels in each segment. This is readily achieved by maintaining a pointer to a cluster for each original pixel address. As clusters are merged, the pointers are updated so that the destination of every pixel is tracked.

The other goal is to produce an output picture with new pixel values that are identical for every pixel within a segment and whose value is in some way representative of that segment. Three possible methods of calculating these pixel values have been identified:

1. Use the values that the clusters already possess

2. Take the values that the clusters already possess and renormalize them so that the standard deviation of the values in each dimension equals the corresponding original standard deviation

3. Replace the values with the mean, or some other representative value, of the original pixel values in each cluster

Formal Descriptions

There now follows a formal description of more important aspects of the method.

The original picture, at time t=0, consists of M₀ point masses, one for each pixel, whose spatial/temporal coordinates are

gᵢ^{j}(0), j=1 . . . S, i=1 . . . M₀

and whose pixel values are

gᵢ^{S+j}(0), j=1 . . . P, i=1 . . . M₀

For example, if the image to be segmented is two-dimensional and has Mₓ pixels per line and M_{y} lines, then

S=2

M₀=MₓM_{y}

gᵢ¹(0)=i mod Mₓ

gᵢ²(0)=└i/Mₓ┘

If the pixels in that image are luminance and colour difference values Yᵢ, Uᵢ and Vᵢ, then

P=3

gᵢ³(0)=Yᵢ

gᵢ⁴(0)=Uᵢ

gᵢ⁵(0)=Vᵢ

In general, the picture at time t consists of Mₜ points, sometimes also referred to as clusters, whose coordinates are

gₘ^{j}(t), j=1 . . . N, m=1 . . . Mₜ

and the m^{th} cluster consists of pixels whose original (t=0) coordinates i are members of the set Cₘ(t), with

$${⋃}_{m = 1}^{{M}_{t}} {C}_{m} ( t ) = \{ i , i = 1 … {M}_{0}$$

and

Cₘ(t)∩C_{m′}(t)=Φ, ∀m, m′ ε{1 . . . Mₜ}, m≠m′

In other words, the sets Cₘ(t) cover the set of original pixels.

Cluster m then consists of pixels whose original spatial coordinates are

gᵢ^{j}(0), j=1 . . . S, iεCₘ(t)

and whose current pixel values are

gᵢ^{S+j}(t), j=1 . . . P, iεCₘ (t)

The mass of the m^{th} cluster is defined as

Wₘ(t)=|Cₘ(t)|

i.e. the number of elements in the set Cₘ(t). We also define the function which maps original pixels to clusters:

γᵢ(t)=Cₘ(t)|iεCₘ(t)

Note that, at time t=0, the initial assigment of pixels to clusters of unit mass implies the following:

Cₘ(0)={m}

Wₘ(0)=1

γₘ(0)=Cₘ(0)

The operation of the drift and cluster processes described above will now be defined.

Drift Step—Formal Description

In one drift iteration, the coordinates of the clusters are updated as follows:

gᵢ^{j}(t+1)=gᵢ^{j}(t)+Δᵢ^{j}

where

Δᵢ^{j}=rᵢ·dᵢ^{j}

$$\begin{matrix}{d}_{i}^{j} = G {\sum }_{k \neq i}^{} \frac{{W}_{k} ( t ) [ {g}_{k}^{j} ( t ) - {g}_{i}^{j} ( t ) ]}{{\sum }_{l = 1}^{N} {[ {g}_{i}^{l} ( t ) - {g}_{k}^{l} ( t ) ]}^{- \frac{3}{2}}} \\ {r}_{i} = min \{ 1 , \frac{\frac{1}{2} min \{ \sqrt{{\sum }_{j = 1}^{N} {[ {g}_{i}^{j} ( t ) - {g}_{k}^{j} ( t ) ]}^{2}} , k \neq i \}}{\sqrt{{\sum }_{j = 1}^{N} {( {d}_{i}^{j} )}^{2}}} \}\end{matrix}$$

where G is a constant. The multiplier rᵢ has the effect of limiting the distance moved to half the distance between the cluster and its nearest neighbour.

During the drift process, the clusters remain the same:

Cᵢ(t+1)=Cᵢ(t) ∀i

Note that the above formulae assume that the influence of every point on every other point is considered. In practice, methods described in the text above may be used to limit the number of points considered. They also assume that no point is moved until all the update values have been calculated. Again, in practice it is possible to save memory by updating points in-place as described in the text above.

Cluster Step—Formal Description

For simplicity, we will assume that the bins are of size 1 in all dimensions. The clustering phase is then defined as follows:

$${C}_{m} ( t + 1 ) = {⋃}_{i = 1}^{{M}_{t}} {C}_{i} ( t ) \vert ⌊ {g}_{i}^{j} ⌋ = {x}_{m}^{j}$$

where

(xₘ^{j}), j=1 . . . N

is a set of integers defining the coordinates of the m^{th} bin.

The new parameters of the clusters are then defined as follows:

$${g}_{m}^{j} ( t + 1 ) = \frac{{\sum }_{i \vert {C}_{i} ( t ) ∈ {C}_{m} ( t + 1 )}^{} {W}_{i} ( t ) {g}_{i}^{j} ( t )}{{\sum }_{i \vert {C}_{i} ( t ) ∈ {C}_{m} ( t + 1 )}^{} {W}_{i} ( t )}$$

Note that many bins will be empty. New parameters are only calculated for non-empty bins, and the list of bins can be “collapsed” by removing all empty bins. The new number of clusters, M^{t+1}, is then defined as the number of non-empty bins.

Output Processing—Formal Description

The formal definition of the three methods of output processing described in the text above are as follows:

1. hᵢ^{j}=gᵢ^{j}(T)

where T is the time corresponding to the final iteration. This is the method that retains the pixel values attributed to the clusters as the simulation proceeds.

$$2. {h}_{i}^{j} = {g}_{i}^{j} ( T ) \frac{σ \{ {g}_{m}^{j} ( 0 ) , m = 1 … {M}_{0} \}}{σ \{ {g}_{m}^{j} ( T ) , m = 1 … {M}_{T} \}}$$

where

σ{ }

is the standard deviation operator taking the weights Wm(t) into account. This is the method that rescales the pixel values to have the same standard deviation as the original component.

$$3. {h}_{i}^{j} = \frac{{\sum }_{m ∈ {γ}_{i} ( T )}^{} {g}_{m}^{j} ( 0 )}{\vert {γ}_{i} ( T ) \vert}$$

This is the method that replaces the pixel values in each segment with the average of the original pixel values in that segment.

Further Explanation

The following diagrams may help to explain the clustering process. Two examples will be used.

In the first example, illustrated in FIGS. 2 to 8, a two-dimensional image is being segmented. The diagrams show the two spatial dimensions of the picture but do not show the pixel values.

First, the pixels, represented as point masses, are distributed uniformly across the picture. In this example, the bins which will be used for the clustering process are shown with the same spacing as the pixels. This is not strictly necessary but helps to make the explanation simpler.

The initial distribution is shown in FIG. 2.

After one Drift iteration, the pixels move slightly, as in FIG. 3.

After a second iteration, as in FIG. 4, the pixels move further and the signs of clustering appear.

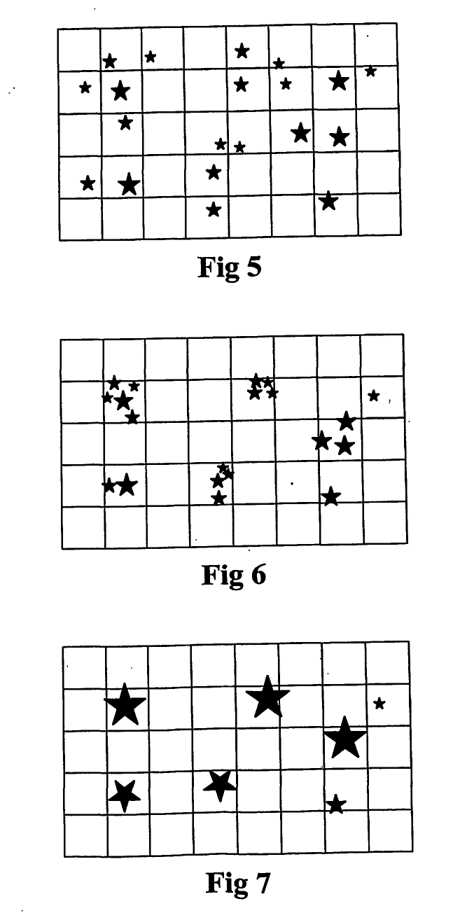

The Cluster process is then invoked to merge points together, as shown in FIG. 5. Now there is only one point in each bin, but the mass of some of the points has increased, while the total mass of all the points remains the same.

After further Drift iterations the picture might look as in FIG. 6, which after the Cluster step would produce the picture shown in FIG. 7.

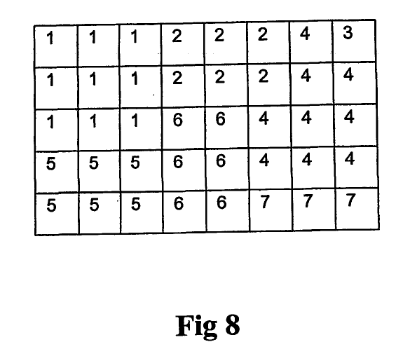

If each cluster is given a number, then by mapping the clusters to original pixels we can produce a segmentation map of the original picture, as shown in FIG. 8.

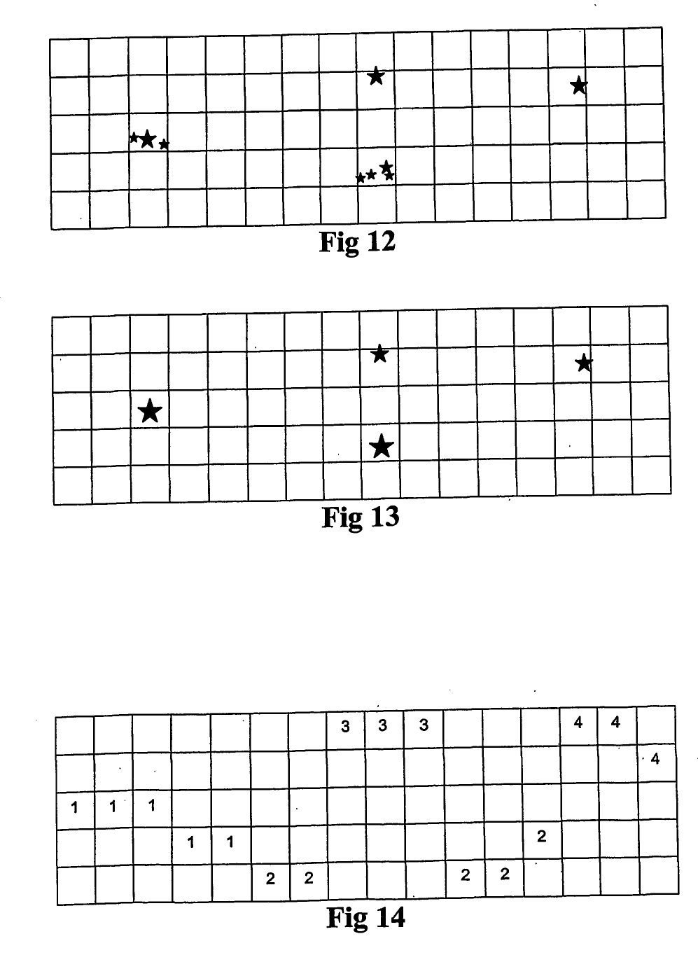

The second example, illustrated in FIGS. 9 to 14, has only one spatial dimension, which is plotted on the horizontal axis. The pixel values, which are also one-dimensional in this case, are plotted on the vertical axis. The initial picture might look like FIG. 9, after one or more Drift iterations, like FIG. 10, after a Cluster operation, like FIG. 11, after further drift steps, like FIG. 12, and after a further Cluster step, like FIG. 13.

This example serves to show that clusters can end up on top of one another in terms of their pixel values, while still referring to distinct areas of the original picture.

The resulting segmentation in this case would be as shown in FIG. 14. Note that the resulting segments need not be contiguous, which is a powerful feature of the algorithm.

Possible Modifications and Refinements

There are many possible modifications which could be made to the method described above. For example:

The initial mass assigned to each pixel need not be 1, but could be a value which expresses some already-known measure of importance of the pixel, or confidence in its correctness.

The renormalization that is described as method 2 of output processing, in which the original standard deviation of each component are restored, may additionally be carried out at various stages during the simulated clustering process.

Alternatively, a fixed repulsive term may be introduced into the simulation, to prevent the standard deviations of the components from diminishing.

Simpler gravitational models may be used. For example, points might always be moved by a fixed distance, or by a distance that is proportional to the mass of the attracting point.

A further simplification might be to allow points to be influenced only by their nearest neighbours, where the measure of nearness may additionally take mass into account.

1. A method of processing multidimensional image data, characterized in that the data is represented as a set of point masses in a vector space which is the product of the vector space of pixel values and the vector space of pixel locations.

2. A method of segmenting multidimensional image data according to claim 1, in which the segments are determined by the result of simulated gravitational clustering of the point masses.

3. A method according to claim 2, in which the simulated gravitational clustering is carried out iteratively over short simulated time intervals.

4. A method according to claim 2, in which the distance moved by each point is limited to a defined fraction the distance between the point and its nearest neighbor.

5. A method according to claim 2, in which from time to time the point masses are merged according to a proximity criterion.

6. A method according to claim 5, in which the proximity criterion is defined by mutual occupancy of a pre-defined hypercube in the vector space.

7. A method according to claim 1, in which the mapping of original pixels to point masses is tracked during the simulation process, so that pixels may be mapped to segments.

8. A method according to claim 1, in which the coordinate values of the point masses are assigned to pixels which map to those point masses.

9. A method according to claim 1, in which the value assigned to the pixels in each segment is the average of the original values of all the pixels in that segment.

10. A method according to claim 1, in which the coordinates of the point masses may from time to time be renormalized.

11. A method according to claim 1, in which the initial values of the point masses are unity.
